(19) United States
(12) Patent Application Publication
(10) Pub. No.: US 2021/0370722 A1
(43) Pub. Date: Dec. 2, 2021

(54) Tire for Passenger Vehicle

(71) Applicant: COMPAGNIE GENERALE DES ETABLISSEMENTS MICHELIN, Clermont-Ferrand (FR)

(72) Inventors: Olivier MUHLHOFF, Clermont-Ferrand Cedex 9 (FR); Benoìt DURAND-GASSELIN, Clermont-Ferrand Cedex 9 (FR); Fabien HELLOT, Clermont-Ferrand Cedex 9 (FR)

(21) Appl. No.: 16/766,390

(22) PCT Filed: Nov. 22, 2018
(86) PCT No.: PCT/FR2018/052950

§ 371 Date: May 22, 2020

(30) Foreign Application Priority Data
Nov. 24, 2017 (FR) 17/61130

(51) Int. Cl. B60C 9/20; B60C 11/03; B60C 11/00; B60C 9/00

(52) U.S. Cl. CPC B60C 9/2009; B60C 11/0304; B60C 11/033; B60C 11/0041; B60C 9/005; B60C 2011/0355; B60C 2009/2016; B60C 2009/2083; B60C 2011/0033; B60C 2011/0334; B60C 2011/0353; B60C 2009/2019

(57) ABSTRACT

A passenger vehicle tire having rolling resistance without negatively affecting the grip and behaviour. The tread (2) has a radial height H_{S} between 5 mm and 8 mm, a volumetric void ratio T_{EV} between 22% and 30%, a total volume V_{CP} of the main voids (241) at least equal to 80% of the total volume V_{C} of the voids (24), and comprises an elastomeric compound having a glass transition temperature T_{g} between 22° C. and 5° C., a Shore A hardness between 45 and 65, and a dynamic loss tgδ at 23° C. at least equal to 0.13 and at most equal to 0.39. The metal reinforcers of the working layers (41, 42) are steel monofilaments having a cross section S with a smallest dimension Dmin between 0.20 mm and 0.50 mm. The monofilaments distributed at a density d_{T} between 100 threads/dm 200 threads/dm, each working layer (41, 42) having a mean radial thickness E_{T} between D+0.1 mm and D+0.6 mm.

The invention relates to a radial tire intended to be fitted to a passenger vehicle, usually known as a passenger vehicle tire.

The tire field that is more particularly involved here is that of passenger vehicle tires, the meridional cross section of which is characterized by a section width S and a section height H, within the meaning of the European Tire and Rim Technical Organisation, or ETRTO, standard, such that the ratio H/S, expressed as a percentage, is at most equal to 70, and the section width S is at least equal to 175 mm. Moreover, the diameter at the seat D, defining the diameter of the mounting rim of the tire, is at least equal to 14 inches, and generally at most equal to 24 inches.

In the following text, and by convention, the circumferential direction XX′, axial direction YY' and radial direction ZZ' refer to a direction tangential to the tread surface of the tire in the direction of rotation of the tire, to a direction parallel to the axis of rotation of the tire, and to a direction perpendicular to the axis of rotation of the tire, respectively. “Radially inside” and “radially outside” mean “closer to the axis of rotation of the tire” and “further away from the axis of rotation of the tire”, respectively. “Axially inside” and “axially outside” mean “closer to the equatorial plane of the tire” and “further away from the equatorial plane of the tire”, respectively, the equatorial plane XZ of the tire being the plane passing through the middle of the tread surface of the tire and perpendicular to the axis of rotation of the tire.

Generally, a tire comprises a tread that is intended to come into contact with the ground via a tread surface and is connected via two sidewalls to two beads that provide the mechanical connection between the tire and the rim on which it is mounted. A radial tire comprises a reinforcement comprising a crown reinforcement radially inside the tread and a carcass reinforcement generally radially inside the crown reinforcement.

The tread comprises raised elements that are separated from one another by voids. The arrangement of the raised elements and the voids makes up the tread pattern of the tread. The raised elements extend radially outwards from a bottom surface to the tread surface. For a tire in the new state, the radial distance between the bottom surface and the tread surface, measured in the equatorial plane of the tire, is referred to as the radial height Hₛ of the raised elements or, more commonly, the tread pattern height Hₛ. The proportion of voids with respect to the raised elements is defined by a volumetric void ratio T_{EV}, which is equal to the ratio between the total volume of the voids and the sum of the respective total volumes of the voids and the raised elements. The total volume of the voids is the sum of the elementary volumes of the voids that typically have an axial width at least equal to 1 mm, in other words of the voids that are not simple sipes. The volumes are measured by way of profile readings of the tread of the new tire, for example, using a laser. The profile of the tread has an axial width equal to the axial width of the tread surface in contact with the ground, when the tire, mounted on its nominal rim, is inflated to its nominal pressure and under its nominal load, said nominal conditions being defined by the ETRTO standard. For the tread of a reference prior art passenger vehicle tire, in the new state, the raised elements generally have a radial height Hₛ at least equal to 6.5 mm and at most equal to 8 mm, and the volumetric void ratio T_{EV} is at least equal to 22% and at most equal to 30%.

Among the voids in the tread that have a total volume V_{C}, there are what are known as main voids, which each have a mean width at least equal to 6 mm and have a total volume V_{CP}. These main voids have the function, in particular, of picking up the water in the contact patch between the tread and the ground and of evacuating it from the contact patch in order to ensure the performance under aquaplaning conditions. They are referred to as substantially circumferential, or longitudinal, voids when their mean line forms an angle at most equal to 45° with the circumferential direction XX′ of the tire. They are referred to as substantially axial, or transverse, voids when their mean line forms an angle at least equal to 45° with the circumferential direction XX′ of the tire.

The tread comprises at least one polymeric material of the elastomeric compound type, that is to say a polymeric material obtained by mixing at least one elastomer, at least one reinforcing filler and a crosslinking system. Usually, the tread is made from a single elastomeric compound.

A normal physical characteristic of an elastomeric compound is its glass transition temperature T_{g}, the temperature at which the elastomeric compound passes from a deformable rubbery state to a rigid glassy state. The glass transition temperature T_{g} of an elastomeric compound is generally determined during the measurement of the dynamic properties of the elastomeric compound, on a viscosity analyser for example of the Metravib VA4000 type, according to the standard ASTM D 5992−96. The dynamic properties are measured on a sample of vulcanized elastomeric compound, that is to say elastomeric compound that has been cured to a degree of conversion of at least 90%, the sample having the form of a cylindrical test specimen having a thickness equal to 2 mm and a cross-sectional area equal to 78.5 mm². The response of the sample of elastomeric compound to a simple alternating sinusoidal shear stress, having a peak-to-peak amplitude equal to 0.7 MPa and a frequency equal to 10 Hz, is recorded. A temperature sweep is carried out at a constant temperature rise rate of +1.5° C./min The results utilized are generally the complex dynamic shear modulus G*, comprising an elastic part G′ and a viscous part G″, and the dynamic loss tgδ, equal to the ratio G″/G′. The glass transition temperature T_{g} is the temperature at which the dynamic loss tgδ reaches a maximum during the temperature sweep.

The mechanical behaviour of an elastomeric compound can be characterized, under static conditions, by its Shore A hardness, measured in accordance with the standards DIN 53505 or ASTM 2240, and, under dynamic conditions, by its complex dynamic shear modulus G*, as described above, at a given temperature, typically at 23° C.

The dissipation of heat, or hysteresis, of an elastomeric compound can be characterized, under static conditions, by its loss factor at 60° C., which is a loss of energy at 60° C., measured by rebound at a set energy level measured at the sixth impact and the value of which, expressed in %, is the ratio of the difference between the energy supplied and the energy returned to the energy supplied. It can also be characterized, under dynamic conditions, by its dynamic loss tgδ, as defined above, at a given temperature, typically 23° C.

The material of which the tread of a reference prior art passenger vehicle tire is made is an elastomeric compound having a glass transition temperature T_{g} at least equal to −12° C. and at most equal to −5° C., a Shore A hardness at least equal to 65 and at most equal to 68, a loss at 60° C. at least equal to 25% and at most equal to 33%, and a dynamic loss tgδ at 23° C. at least equal to 0.32 and at most equal to 0.44.

The crown reinforcement, which is radially inside the tread and usually radially outside the carcass reinforcement, comprises, radially from the outside to the inside, a hoop reinforcement comprising at least one hoop layer and a working reinforcement comprising at least one working layer.

The crown reinforcement has the function of absorbing both the mechanical stresses of inflation, which are generated by the tire inflation pressure and transmitted by the carcass reinforcement, and the mechanical stresses caused by running, which are generated as the tire runs over the ground and are transmitted by the tread. The working reinforcement has the specific function of conferring stiffness in the circumferential, axial and radial directions, and, in particular, road holding on the tire. The hoop reinforcement has the specific function of providing additional circumferential stiffness with respect to the working reinforcement, in order to limit the radial deformations of the tire.

The hoop reinforcement, for a passenger vehicle tire, usually comprises a single hooping layer. A hooping layer comprises reinforcers that are generally made of textile, for example of aliphatic polyamide such as nylon, are coated in an elastomeric compound and are mutually parallel. The reinforcers form, with the circumferential direction XX′ of the tire, an angle A_{F}, measured in the equatorial plane XZ of the tire, at most equal to 5° in terms of absolute value.

The working reinforcement, for a passenger vehicle tire, normally comprises two, radially superposed working layers comprising metal reinforcers that are coated in an elastomeric compound, are mutually parallel in each layer and are crossed from one layer to the next, forming, with the circumferential direction XX′ of the tire, angles (A_{T1}, A_{T2}), measured in the equatorial plane XZ of the tire, with an absolute value generally at least equal to 20° and at most equal to 40°. The working reinforcement has an axial width L_{T}, defined as being the maximum axial width of the working layers, at least equal to the axial width L_{F} of the hoop reinforcement, usually defined as being the axial width of the single hooping layer.

The metal reinforcers of the working layers are cords made up of an assembly of metal threads, generally made of steel and, more precisely, carbon steel. By way of example, the metal reinforcers used for the prior art passenger vehicle tire, taken as reference, is a 2.30 cord made up of a twisted assembly of two metal threads that each have a diameter equal to 0.30 mm.

Generally, a metal reinforcer is characterized mechanically by a curve representing the tensile force (in N), applied to the metal reinforcer, as a function of the relative elongation (in %) of the metal reinforcer, referred to as the force-elongation curve. Mechanical tensile characteristics, such as the structural elongation Aₛ (in %), the total elongation at break Aₜ (in %), the force at break Fₘ (maximum load in N) and the breaking strength Rₘ (in MPa) are derived from this force-elongation curve, these characteristics being measured in accordance with the standard ISO 6892 of 1984.

The total elongation at break Aₜ of the metal reinforcer is, by definition, the sum of the structural, elastic and plastic elongations thereof (Aₜ=Aₛ+Aₑ+Aₚ). The structural elongation Aₛ results from the relative positioning of the metal threads making up the metal reinforcer under a low tensile force. The elastic elongation Aₑ results from the actual elasticity of the metal of the metal threads, making up the metal reinforcer, taken individually (Hooke's law). The plastic elongation Aₚ results from the plasticity (irreversible deformation beyond the yield point) of the metal of these metal threads taken individually. These different elongations and the respective meanings thereof, which are well known to a person skilled in the art, are described, for example, in the documents U.S. Pat. No. 5,843,583, WO 2005014925 and WO 2007090603.

Also defined, at any point on the force-elongation curve, is a tensile modulus (in GPa), which represents the gradient of the straight line tangential to the force-elongation curve at this point. In particular, the tensile modulus of the elastic linear part of the force-elongation curve is referred to as the elastic tensile modulus or Young's modulus.

The metal reinforcers of the working layers are usually inextensible, that is to say are characterized by a relative elongation, under a tensile force equal to 10% of the force at break Fₘ, at most equal to 0.2% and an elastic tensile modulus of usually between 150 GPa and 200 GPa.

Radially on the inside of the crown reinforcement, the carcass reinforcement comprises generally at least one carcass layer comprising reinforcers that are usually made of textile material, are coated in an elastomeric material and are mutually parallel. The reinforcers of a carcass layer form an angle A_{C} at least equal to 85° and at most equal to 95° with the circumferential direction XX′ of the tire. A textile material commonly used for the reinforcers of a carcass layer, for a prior art passenger vehicle tire, is a polyester such as a polyethylene terephthalate (PET).

A carcass layer may or may not have a turnup. A carcass layer is said to have a turnup when it comprises a main part that connects the two beads of the tire together and is wrapped, in each bead, from the inside of the tire to the outside around a circumferential reinforcing element or bead wire so as to form a turnup having a free end. A carcass layer does not have a turnup when it is made up only of a main part that connects the two beads together without being wrapped around a bead wire.

The main performance aspects for a passenger vehicle tire are, non-exhaustively, longitudinal and transverse grip on wet ground and on dry ground, behaviour, in particular at low transverse acceleration, wear, and rolling resistance.

Currently, motor vehicle manufacturers are expressing strong demand for lower rolling resistance so as to reduce fuel consumption. However, a person skilled in the art is familiar with the fact that rolling resistance is lowered generally to the detriment of other key performance aspects such as the various types of grip (longitudinal/transverse, on dry/wet ground) or behaviour.

Moreover, the search for the lowest possible tire mass is a constant concern for tire designers in order to reduce the mass of the vehicle on which the tire is fitted. Reducing the mass of tires also makes it possible to reduce the inertia thereof, and consequently to reduce the fuel consumption of the vehicle. A reduction in tire mass also makes it possible to lighten the vehicle via precise optimization of each component thereof, for example the brake system since it exhibits less inertia and mass to be braked. A reduction in mass also makes it possible to reduce the quantity of raw materials required to manufacture the tire, and thus to preserve natural resources. Moreover, this reduction in tire mass should not have a negative effect on the endurance thereof.

The inventors have set themselves the objective of improving, compared with a prior art passenger vehicle tire as described above, the compromise between rolling resistance and opposing performance aspects such as the various types of grip (longitudinal/transverse, on dry/wet ground) and behaviour, while reducing the mass without having a negative effect on endurance.

This aim has been achieved according to the invention by a tire for a passenger vehicle, comprising:
A tread that is intended to come into contact with the ground via a tread surface and comprises raised elements extending radially outwards from a bottom surface to the tread surface over a radial height H_{S}, measured in an equatorial plane XZ of the tire, at most equal to 8mm,
the raised elements having a total volume V_{P} and being separated by voids having a total volume V_{C}, some of the voids being main voids, each having a mean width at least equal to 6 mm, and the set of main voids having a total volume V_{CP},
the tread having a volumetric void ratio T_{EV}, defined as being the ratio between the total volume V_{C} of the voids and the sum of the total volume V_{C} of the voids and the total volume V_{P} of the raised elements, at least equal to 22% and at most equal to 30%,
the tread also comprising at least one elastomeric compound having a glass transition temperature T_{g}, a Shore A hardness and a dynamic loss tgδ at 23° C.,
a hoop reinforcement, radially on the inside of the tread, comprising at least one hooping layer comprising textile reinforcers that are coated in an elastomeric compound, are mutually parallel and form, with a circumferential direction XX′ of the tire, an angle A_{F}, measured in the equatorial plane XZ of the tire, at most equal to 5° in terms of absolute value,
a working reinforcement, radially on the inside of the hoop reinforcement, comprising at least two, radially superposed working layers comprising metal reinforcers that are coated in an elastomeric compound, are mutually parallel in each layer and are crossed from one layer to the next, forming, with the circumferential direction XX′ of the tire, an angle (A_{T1}, A_{T2}), measured in the equatorial plane XZ of the tire, with an absolute value at least equal to 20° and at most equal to 40°,
a carcass reinforcement comprising at least one carcass layer comprising textile reinforcers that are coated in an elastomeric material, are mutually parallel and form, with the circumferential direction XX′ of the tire, an angle A_{C} at least equal to 85° and at most equal to 95°,
the radial height H_{S} of the raised elements of the tread being at least equal to 5 0 mm,

the total volume V_{CP} of the set of main voids in the tread being at least equal to 80% of the total volume V_{C} of the voids in the tread,
and the at least one elastomeric compound that makes up the tread having a glass transition temperature T_{g} at least equal to −22° C. and at most equal to −5° C., a Shore A hardness at least equal to 45 and at most equal to 65, and a dynamic loss tgδ at 23° C. at least equal to 0.13 and at most equal to 0.39,
the metal reinforcers of each of the at least two working layers of the working reinforcement being steel monofilaments having a cross section S inscribed in a circle of diameter D, the smallest dimension Dmin of which is at least equal to 0.20 mm and at most equal to 0 5 mm,
the metal reinforcers of each of the at least two working layers of the working reinforcement being distributed at a density d_{T} at least equal to 100 threads/dm and at most equal to 200 threads/dm,
and each working layer of the working reinforcement having a mean radial thickness E_{T} at least equal to D+0.1 mm and at most equal to D+0 6 mm, where D is the diameter of the circle circumscribed on the cross section S of the monofilament-type metal reinforcer.

A tread according to the invention is therefore characterized geometrically by a radial height H_{S} of its raised elements that is limited, between 5 mm and 8 mm, and a total volume V_{CP} of the set of main voids that is rather high, at least equal to 80% of the total volume V_{C} of the voids. In terms of material, the tread according to the invention is characterized by an elastomeric compound having a glass transition temperature, comprised in a wide range, between −22° C. and −5° C., having a rather low hardness, having a Shore A hardness of between 45 and 65, and having fairly low hysteresis, with a dynamic loss tgδ at 23° C. at least equal to 0.13 and at most equal to 0.39. This elastomeric compound is also characterized by a loss at 60° C. at least equal to 12% and at most equal to 30%.

A tread elastomeric compound having low hysteresis contributes toward low rolling resistance, this effect being reinforced by the limited radial height of the raised elements of the tread.

Furthermore, a tread elastomeric compound with low hardness, which is thus rather soft, makes it possible to increase grip on wet ground but has a negative effect on behaviour. However, the negative impact of the soft elastomeric compound on the behaviour is at least partially compensated by a low radial height of the raised elements of the tread.

As regards the glass transition temperature T_{g}, a fairly wide range of values makes it possible to alter the compromise between rolling resistance and grip on wet ground: a rather low glass transition temperature T_{g} is favourable for rolling resistance, while a rather high glass transition temperature T_{g} is favourable for grip.

Finally, a high total volume V_{CP} of the set of main voids contributes towards good grip on wet ground, in particular when there is a great depth of standing water, by virtue of its effect of picking up and evacuating water.

As regards the working reinforcement, the metal reinforcers of each of the at least two working layers of the working reinforcement are steel monofilaments having a cross section S inscribed in a circle of diameter D, the smallest dimension Dmin of which is at least equal to 0.20 mm and at most equal to 0.5 mm

The monofilaments are, by definition, individual metal threads. The monofilaments can have any cross-sectional shape, preferably circular or oblong. For a monofilament having a circular cross section S of diameter D, the largest dimension Dmax of the circular cross section S corresponds to the diameter D. An oblong cross section is advantageous compared with a circular cross section of the same smallest dimension Dmin, since it has higher flexural inertia, giving the monofilament better resistance to buckling.

The monofilaments may or may not be rectilinear. They may be preformed, of sinusoidal, zigzag, or wavy shape, or following a spiral.

The monofilaments are made of steel, preferably carbon steel such as those used in cords of the “steel cords” type, although it is of course possible to use other steels, for example stainless steels, or other alloys. When a carbon steel is used, its carbon content (% by weight of steel) is preferably in a range from 0.8% to 1.2%. The invention is particularly applicable to steels of the very high strength “SHT” (“Super High Tensile”), ultra-high strength “UHT” (“Ultra High Tensile”) or “MT” (“Mega Tensile”) steel cord type. The carbon steel reinforcers then have an ultimate tensile strength Rm that is preferably higher than 3000 MPa, more preferably higher than 3500 MPa. Their total elongation at break At is preferably greater than 2.0%.

The steel used, whether it is in particular a carbon steel or a stainless steel, may itself be coated with a layer of metal, which improves for example the workability of the steel monofilament or the wear properties of the reinforcer and/or of the tire themselves, such as properties of grip, corrosion resistance or even resistance to ageing. According to one preferred embodiment, the steel used is covered with a layer of brass (Zn—Cu alloy) or of zinc; it will be recalled that, during the process of manufacturing the threads, the brass or zinc coating makes the thread easier to draw, and makes the thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

Furthermore, the metal reinforcers of each of the at least two working layers of the working reinforcement are distributed at a density d_{T} at least equal to 100 threads/dm and at most equal to 200 threads/dm.

Density is understood as meaning the mean number of monofilaments over a 10-cm width of the working layer, this width being measured perpendicularly to the direction of the monofilaments in the working layer in question. The distance between two consecutive monfilaments or spacing may be fixed. The monofilaments may be laid during manufacture either in layers, in strips, or individually. A monofilament density in each working layer that is at least equal to 100 threads per dm and at most equal to 200 threads per dm ensures a satisfactory fatigue breaking strength of the monofilaments and good shear strength of the elastomeric compounds situated between the filaments.

Moreover, the resistance of a monofilament to buckling is also dependent on the resistance of the axially adjacent monofilaments, the onset of buckling in one being able to lead to the buckling of another through the effect of a distribution of the load around the monofilament that is buckling. In order to obtain an improved performance in terms of endurance, it may be advantageous not only to comply with conditions of section diameter and density of the monofilaments but also to fulfil a condition relating to the breaking strength R_{C} defined by R_{C}=Rm*S*d_{T}, where Rm is the ultimate tensile strength of the monofilaments in MPa, S is the cross-sectional area of the monofilaments in mm², and d_{T} is the density of monofilaments in the working layer in question, in number of monofilaments per dm. Advantageously, the breaking strength R_{C} of each working layer should be at least equal to 30 000 N/dm.

Since the metal reinforcers according to the invention are monofilaments, each working layer of the working reinforcement has a mean radial thickness E_{T} at least equal to D+0.1 mm and at most equal to D+0.6 mm, where D is the diameter of the circle circumscribed on the cross section S of the monofilament-type metal reinforcer. Since a monofilament is interposed between a radially inner thickness of elastomeric compound and a radially outer thickness of elastomeric compound, these two thicknesses usually being substantially the same, the mean radial thickness E_{T} of the working layer is equal to the sum of the diameter D and the two, respectively radially inner and radially outer, thicknesses of elastomeric compound. Consequently, in the case of a substantially symmetric distribution of the elastomeric compound respectively radially on the inside and radially on the outside of the monofilaments, the range of mean radial thickness E_{T} of the specified working layer implies that each respectively radially inner and radially outer thickness of elastomeric compound is at least equal to 0.05 mm and at most equal to 0.3 mm. This thickness is substantially less than that obtained for cord-type metal reinforcers, which are made up of an assembly of a plurality of individual threads, whence a saving in mass of the working layers and thus of the tire.

In conclusion, the combination of essential features of the invention, relating to the tread and the working reinforcement, clearly makes it possible to provide an advantage in terms of rolling resistance without having a negative effect on grip and behaviour. Finally, it allows a decrease in the mass of the tire.

Preferably, the radial height H_{S} of the raised elements of the tread is at least equal to 5.5 mm and at most equal to 7.5 mm, preferably at most equal to 7 mm. This range of values for the radial height makes it possible to obtain a satisfactory compromise between the performance in terms of rolling resistance, behaviour and grip on wet ground.

Advantageously, the volumetric void ratio T_{EV}of the tread is at most equal to 28%. Preferably, the volumetric void ratio T_{EV} of the tread is at least equal to 25% and at most equal to 27%. This range of values of the void ratio makes it possible to ensure good performance in terms of grip on wet ground, by virtue of a void ratio of the tread that is sufficiently high to compensate for a limited tread pattern height.

Further advantageously, the total volume V_{CP} of the set of main voids in the tread is at least equal to 85%, preferably at least equal to 88%, of the total volume V_{C} of the voids in the tread. Usually, the majority of the main voids are circumferential, meaning that the raised elements of the tread are disposed mainly circumferentially and constitute circumferential ribs, which may be continuous or discontinuous. In the case of discontinuous ribs, the raised elements are then made up of blocks separated by sipes, that is to say voids of very small thickness. When the tire is compressed and/or rolling under a drive torque, the blocks, which constitute the discontinuous ribs, come into contact circumferentially in pairs, this limiting their circumferential deformations by the Poisson effect, and, correspondingly, their dissipation of heat, whence a reduction in rolling resistance.

Preferably, the at least one elastomeric compound that makes up the tread has a glass transition temperature T_{g} at least equal to −16° C. and at most equal to −8° C. This range of values of the glass transition temperature T_{g} makes it possible to achieve a satisfactory compromise between rolling resistance and grip on wet ground, with a glass transition temperature T_{g} that is sufficiently low to be favourable for rolling resistance and sufficiently high to be favourable for grip on wet ground.

Advantageously, the at least one elastomeric compound that makes up the tread has a Shore A hardness at least equal to 50 and at most equal to 63. Likewise advantageously, the at least one elastomeric compound that makes up the tread has a Shore A hardness at least equal to 52 and at most equal to 57. These ranges of values of Shore A hardness make it possible to achieve a satisfactory compromise between behaviour and grip, with a Shore A hardness that is sufficiently low (soft elastomeric compound) to be favourable for grip and sufficiently high (stiff elastomeric compound) to be favourable for behaviour.

Further advantageously, the at least one elastomeric compound that makes up the tread has a dynamic loss tgδ at 23° C. at most equal to 0.27. This upper limit of the dynamic loss tgδ, and thus of hysteresis, makes a significant contribution towards reducing the rolling resistance.

According to a preferred embodiment of the hoop reinforcement, the textile reinforcers of the at least one hooping layer of the hoop reinforcement comprise an aromatic polyamide, such as aramid. Aramid has a high tensile modulus and thus low deformability, this being favourable for a hooping function of the tire.

According to a first variant of the preferred embodiment of the hoop reinforcement, the textile reinforcers of the at least one hooping layer of the hoop reinforcement comprise a combination of an aromatic polyamide, such as aramid, and an aliphatic polyamide, such as nylon. Such reinforcers are also known as hybrid reinforcers and exhibit the advantage of having mechanical tensile behaviour known as “bimodulus”, characterized by a low tensile modulus, that of nylon, and thus high deformability, for small elongations, and a high tensile modulus, and thus lower deformability, for large elongations.

According to a second variant of the preferred embodiment of the hoop reinforcement, the textile reinforcers of the at least one hooping layer of the hoop reinforcement comprise a combination of an aromatic polyamide, such as aramid, and a polyester, such as polyethylene terephthalate (PET). Such reinforcers are also hybrid reinforcers, which have the same advantages as those described above.

According to a preferred embodiment of the working reinforcement, the metal reinforcers of each of the at least two working layers of the working reinforcement form, with the circumferential direction XX′ of the tire, an angle (A_{T1}, A_{T2}), measured in the equatorial plane XZ of the tire, with an absolute value at least equal to 20° and at most equal to 30°.

According to a preferred embodiment of the metal reinforcers of the working layer, the metal reinforcers of each of the at least two working layers of the working reinforcement are monofilaments having a cross section S, the smallest dimension Dmin of which is at least equal to 0.30 mm and at most equal to 0.4 mm, preferably at least equal to 0.32 mm and at most equal to 0.36 mm. This range of values leads to an optimal compromise between the saving of mass and the buckling strength of the monofilaments of the working layers.

According to a variant of the preferred embodiment of the metal reinforcers of the working layer, the metal reinforcers of each of the at least two working layers of the working reinforcement are steel monofilaments, the ultimate tensile strength Rm of which is at least equal to 3000 MPa, preferably at least equal to 3500 MPa. These minimum values of ultimate tensile strength Rm correspond to carbon steel monofilaments having a carbon content of between 0.8% and 1.2% (% by weight of steel).

Preferably, the metal reinforcers of each of the at least two working layers of the working reinforcement are distributed at a density d_{T} at least equal to 120 threads/dm and at most equal to 180 threads/dm. This range of density values ensures an improved endurance of the elastomeric compound, which is interposed between the monofilaments and subjected to shear, and the mechanical endurance of the monofilaments in tension and compression.

According to a preferred embodiment of each working layer, each working layer of the working reinforcement has a mean radial thickness E_{T} at least equal to D+0.3 mm and at most equal to D+0.5 mm, where D is the diameter of the circle circumscribed on the cross section S of the monofilament-type metal reinforcer. Consequently, in the case of a substantially symmetric distribution of the elastomeric compound respectively radially on the inside and radially on the outside of the monofilaments, the range of mean radial thickness E_{T} of the specified working layer implies that each respectively radially inner and radially outer thickness of elastomeric compound in line with a monofilament is at least equal to 0.15 mm and at most equal to 0.25 mm.

Since the carcass reinforcement generally comprises at least one carcass layer comprising reinforcers that are usually made of textile material, are coated in an elastomeric material and are mutually parallel, it preferably comprises either a single carcass layer or two carcass layers. Further preferably, the textile reinforcers of the carcass layer are made of polyethylene terephthalate (PET).

According to one particular embodiment, the reinforcement of the tire has an architecture of the “shoulder lock” type, characterized by a carcass reinforcement comprising a carcass layer said to have a turnup, that is to say which is wrapped, in each bead of the tire, about a circumferential reinforcing element or bead wire in order to form a turnup, the free end of which comes into contact with the radially inner face of the crown reinforcement.

Advantageously, an intermediate layer comprising at least one elastomeric compound is positioned radially on the inside of the tread and radially on the outside of the hoop reinforcement.

The intermediate layer advantageously has a radial thickness E at least equal to 0.3 mm and at most equal to 4.0 mm

The at least one elastomeric compound that makes up the intermediate layer further advantageously has a Shore A hardness at least equal to 59 and at most equal to 69 and a dynamic loss tgδ at 23° C. at least equal to 0.08 and at most equal to 0.20. This elastomeric compound also has a loss at 60° C. at least equal to 8% and at most equal to 16%. Such an elastomeric compound of the intermediate layer contributes towards a low rolling resistance.

According to an advantageous variant of the tread pattern of the tread, the arrangement of the raised elements of the tread is asymmetric with respect to the equatorial plane XZ of the tire, such that the volumetric void ratio T_{EV1} of the tread half intended to be mounted on the inboard side of the vehicle is at least equal to the volumetric void ratio T_{EV2} of the tread half intended to be mounted on the outboard side of the vehicle.

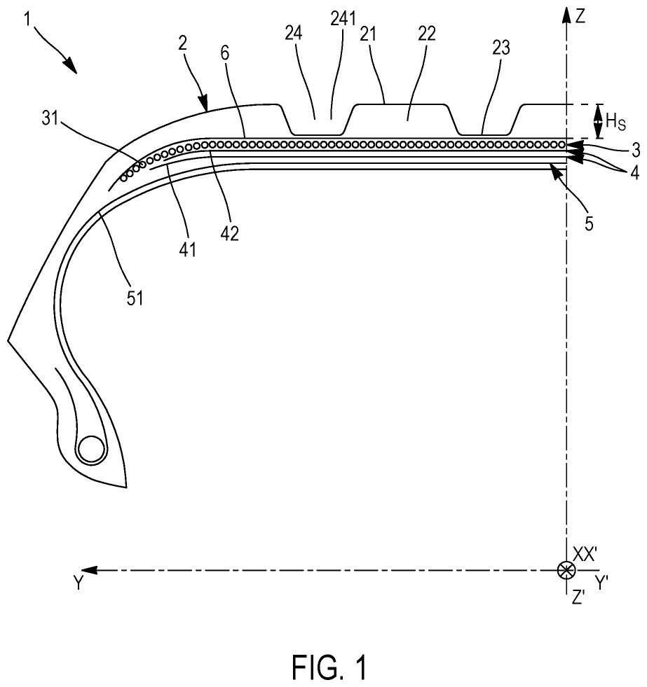

The invention is illustrated in FIGS. 1 to 3, which are not to scale and are described below:

FIG. 1 shows a meridian half-section through a tire according to the invention.

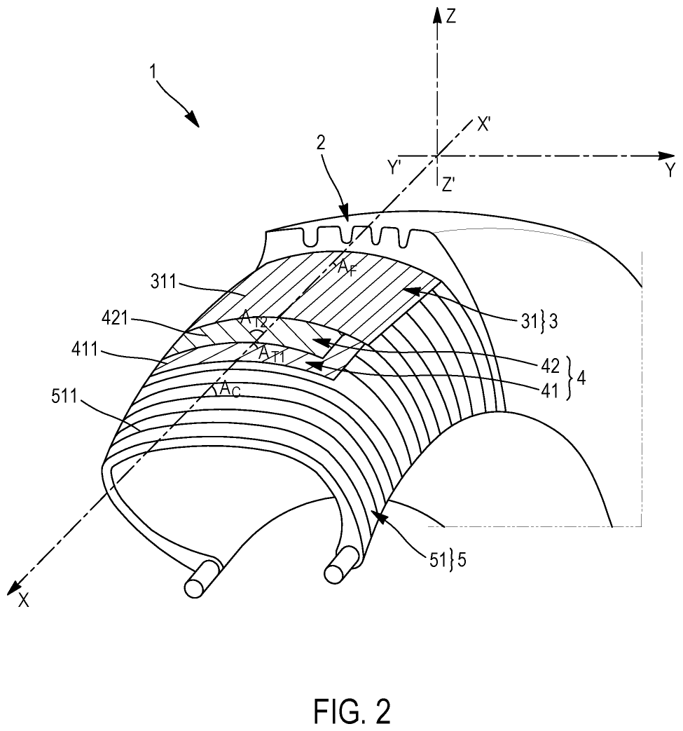

FIG. 2 shows a perspective cross section through a tire according to the invention.

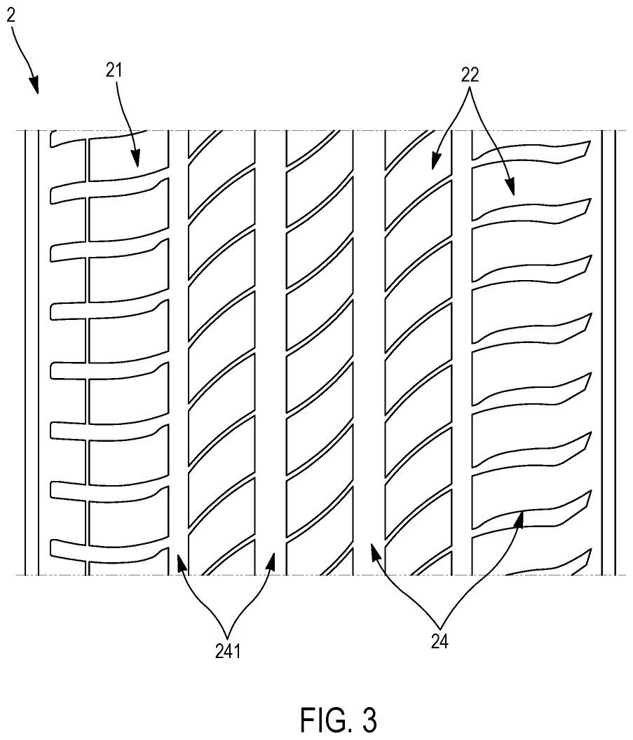

FIG. 3 shows a standard tread of a tire according to the invention.

FIG. 1 shows a meridian half-section, in a meridian plane YZ, through a tire 1 for a passenger vehicle according to the invention. The tire 1 comprises, radially outermost, a tread 2 that is intended to come into contact with the ground via a tread surface 21 and comprises raised elements 22 extending radially outwards from a bottom surface 23 to the tread surface 21 over a radial height H_{S}, measured in an equatorial plane XZ of the tire, at least equal to 5 mm and at most equal to 8 mm. The raised elements 22 have a total volume V_{P} and are separated by voids 24 having a total volume V_{C}. Some of the voids 24 are main voids 214, which each have a mean width at least equal to 6 mm, the set of main voids 241 having a total volume V_{CP} at least equal to 80% of the total volume V_{C} of the voids 24 in the tread 2. The tread 2 has a volumetric void ratio T_{EV}, defined as being the ratio between the total volume V_{C} of the voids 24 and the sum of the total volume V_{C} of the voids 24 and the total volume V_{P} of the raised elements 22, at least equal to 22% and at most equal to 30%. The tread 2 is made up of an elastomeric compound having a glass transition temperature T_{g} at least equal to −22° C. and at most equal to −5° C., a Shore A hardness at least equal to 45 and at most equal to 65, and a dynamic loss tgδ at 23° C. at least equal to 0.13 and at most equal to 0.39. The tire 1 further comprises, according to a particular embodiment of the invention, an intermediate layer 6 that comprises an elastomeric compound and is positioned radially on the inside of the tread 2. The tire 1 also comprises a hoop reinforcement 3, which is radially inside the intermediate layer 6 and comprises a hooping layer 31, a working reinforcement 4, which is radially inside the hoop reinforcement 3 and comprises two, radially superposed working layers (41, 42), and, finally, a carcass reinforcement 5 comprising a carcass layer 51.

FIG. 2 shows a perspective cross section through a tire according to the invention.

The hooping layer 31 comprises textile reinforcers 311 that are coated in an elastomeric compound, are mutually parallel and form, with a circumferential direction XX′ of the tire, an angle A_{F}, measured in the equatorial plane XZ of the tire, at most equal to 5° in terms of absolute value. The two working layers (41, 42) each comprise metal reinforcers (411, 421) that are coated in an elastomeric compound, are mutually parallel in each layer and are crossed from one layer to the next, forming, with the circumferential direction XX′ of the tire, an angle (A_{T1}, A_{T2}), measured in the equatorial plane XZ of the tire, with an absolute value at least equal to 20° and at most equal to 40°. The carcass layer 51 comprises textile reinforcers 511 that are coated in an elastomeric material, are mutually parallel and form, with the circumferential direction XX′ of the tire, an angle A_{C} at least equal to 85° and at most equal to 95°.

FIG. 3 shows a top view of a tread of a tire according to the invention. The tread 2, which is intended to come into contact with the ground via a tread surface 21, comprises raised elements 22, having a total volume V_{P}, which are separated by voids 24, having a total volume V_{C}. Some of the voids are main voids 241, each having a mean width at least equal to 6 mm, the set of main voids 241 having a total volume V_{CP}. In the case shown, the main voids 241 are circumferential. The tread 2 has a volumetric void ratio T_{EV}, defined as being the ratio between the total volume V_{C} of the voids 24 and the sum of the total volume V_{C} of the voids 24 and the total volume V_{P} of the raised elements 22, at least equal to 22% and at most equal to 30%. In addition, the total volume V_{CP} of the set of main voids 241 in the tread 2 is at least equal to 80% of the total volume V_{C} of the voids 24 in the tread 2.

The invention has been studied more particularly in the case of a passenger vehicle tire of size 225/45R17. A first reference tire R1 was compared with a first tire I1 according to the invention, and a second reference tire R2 was compared with a first tire I2 according to the invention.

The tread of the first reference tire R1 comprises raised elements extending radially over a radial height H_{S} equal to 7.5 mm. The volumetric void ratio T_{EV} of the tread is equal to 23%. The elastomeric compound that makes up the tread has a glass transition temperature T_{g} equal to −5° C., a Shore A hardness equal to 67, and a dynamic loss tgδ at 23° C. equal to 0.44. The first reference tire R1 also comprises an intermediate layer radially on the inside of the tread and radially on the outside of the hoop reinforcement, said intermediate layer being made up of an elastomeric compound having a Shore A hardness equal to 66 and a dynamic loss tgδ at 23° C. equal to 0.13. The hoop reinforcement comprises a hooping layer, the textile reinforcers of which are made of nylon with a titre of 140/2 (assembly of 2 strands of 140 tex each, 1 tex being the mass in g of 1000 m of thread) and are distributed in the hooping layer at a density of 98 threads/dm. The working reinforcement comprises two, radially superposed working layers. The metal reinforcers of formulation 2.30 (twisted assembly of two metal threads that each have a diameter equal to 0.30 mm) of the radially innermost working layer and of the radially outermost working layer are distributed at a spacing equal to 1.05 mm and form, with the circumferential direction XX′ of the tire, an angle (A_{T1}, A_{T2}), measured in the equatorial plane XZ of the tire, equal to +25° and −25°, respectively. The mean radial thickness E_{T} of each working layer is equal to 0.9 mm. The carcass reinforcement is made up of a carcass layer, the textile reinforcers of which are made of polyethylene terephthalate (PET) with a titre of 334/2 (assembly of 2 strands of 334 tex each), with a twist of 270 turns/m, and are distributed in the carcass layer at a density of 80 threads/dm.

The tread of the first tire II according to the invention comprises raised elements extending radially over a radial height Hₛ equal to 7 mm. The volumetric void ratio T_{EV} of the tread is equal to 26.5%. The total volume V_{CP} of the set of main voids in the tread is equal to 81% of the total volume V_{C} of the voids in the tread. The elastomeric compound that makes up the tread has a glass transition temperature T_{g} equal to −12° C., a Shore A hardness equal to 63.5, and a dynamic loss tgδ at 23° C. equal to 0.38. The first tire I1 according to the invention also comprises an intermediate layer radially on the inside of the tread and radially on the outside of the hoop reinforcement, said intermediate layer being made up of an elastomeric compound having a Shore A hardness equal to 63 and a dynamic loss tgδ at 23° C. equal to 0.15. The hoop reinforcement comprises a hooping layer, the textile reinforcers of which are made of nylon with a titre of 140/2 (assembly of 2 strands of 140 tex each, 1 tex being the mass in g of 1000 m of thread) and are distributed in the hooping layer at a density of 98 threads/dm. The working reinforcement comprises two, radially superposed working layers. The metal reinforcers of formulation 1.32 (monofilament having in each case a diameter equal to 0.32 mm) of the radially innermost working layer and of the radially outermost working layer are distributed at a spacing equal to 0.70 mm and form, with the circumferential direction XX′ of the tire, an angle (A_{T1}, A_{T2}), measured in the equatorial plane XZ of the tire, equal to +25° and −25°, respectively. The mean radial thickness E_{T} of each working layer is equal to 0.83 mm. The spacing between two consecutive monofilaments, that is to say the distance between their respective mean lines, is equal to 0.70 mm, and so the density of monofilaments is equal to 1/0.70=1.42 reinforcer/mm, i.e. 142 reinforcers/dm. The carcass reinforcement is made up of a carcass layer, the textile reinforcers of which are made of polyethylene terephthalate (PET) with a titre of 334/2 (assembly of 2 strands of 334 tex each), with a twist of 270 turns/m, and are distributed in the carcass layer at a density of 80 threads/dm.

The tread of the second reference tire R2 comprises raised elements extending radially over a radial height Hₛ equal to 7.5 mm. The volumetric void ratio T_{EV} of the tread is equal to 23%. The elastomeric compound that makes up the tread has a glass transition temperature T_{g} equal to −9° C., a Shore A hardness equal to 65, and a dynamic loss tgδ at 23° C. equal to 0.32. The second reference tire R2 also comprises an intermediate layer radially on the inside of the tread and radially on the outside of the hoop reinforcement, said intermediate layer being made up of an elastomeric compound having a Shore A hardness equal to 65 and a dynamic loss tgδ at 23° C. equal to 0.11. The hoop reinforcement comprises a hooping layer, the textile reinforcers of which are made of nylon with a titre of 140/2 (assembly of 2 strands of 140 tex each, 1 tex being the mass in g of 1000 m of thread) and are distributed in the hooping layer at a density of 98 threads/dm. The working reinforcement comprises two, radially superposed working layers. The metal reinforcers of formulation 2.30 (twisted assembly of two metal threads that each have a diameter equal to 0.30 mm) of the radially innermost working layer and of the radially outermost working layer are distributed at a spacing equal to 1.05 mm and form, with the circumferential direction XX′ of the tire, an angle (A_{T1}, A_{T2}), measured in the equatorial plane XZ of the tire, equal to +25° and −25° , respectively. The mean radial thickness E_{T} of each working layer is equal to 0.90 mm. The carcass reinforcement is made up of a carcass layer, the textile reinforcers of which are made of polyethylene terephthalate (PET) with a titre of 334/2 (assembly of 2 strands of 334 tex each), with a twist of 270 turns/m, and are distributed in the carcass layer at a density of 80 threads/dm.

The tread of the second tire I2 according to the invention comprises raised elements extending radially over a radial height H_{S} equal to 7 mm. The volumetric void ratio T_{EV} of the tread is equal to 26.5%. The total volume V_{CP} of the set of main voids in the tread is equal to 90% of the total volume V_{C} of the voids in the tread. The elastomeric compound that makes up the tread has a glass transition temperature T_{g} equal to −14° C., a Shore A hardness equal to 52, and a dynamic loss tgδ at 23° C. equal to 0.18. The second tire I2 according to the invention also comprises an intermediate layer radially on the inside of the tread and radially on the outside of the hoop reinforcement, said intermediate layer being made up of an elastomeric compound having a Shore A hardness equal to 60 and a dynamic loss tgδ at 23° C. equal to 0.10. The hoop reinforcement comprises a hooping layer, the textile reinforcers of which comprise a combination of aramid threads and nylon threads with a titre of A167/N140 (assembly of one strand of aramid of 167 tex and one strand of nylon of 140 tex) with a twist of 290 turns/m, and are distributed in the carcass layer at a density of 98 threads/dm. The working reinforcement comprises two, radially superposed working layers. The metal reinforcers of formulation 1.32 (monofilament having in each case a diameter equal to 0.32 mm) of the radially innermost working layer and of the radially outermost working layer are distributed at a spacing equal to 0.70 mm and form, with the circumferential direction XX′ of the tire, an angle (A_{T1}, A_{T2}), measured in the equatorial plane XZ of the tire, equal to +25° and −25° , respectively. The mean radial thickness E_{T} of each working layer is equal to 0.83 mm. The spacing between two consecutive monofilaments, that is to say the distance between their respective mean lines, is equal to 0.70 mm, and so the density of monofilaments is equal to 1/0.70=1.42 reinforcer/mm, i.e. 142 reinforcers/dm. The carcass reinforcement is made up of a carcass layer, the textile reinforcers of which are made of polyethylene terephthalate (PET) with a titre of 334/2 (assembly of 2 strands of 334 tex each), with a twist of 270 turns/m, and are distributed in the carcass layer at a density of 80 threads/dm.

The mass of the first reference tire R1 is equal to 9.1 kg, and the mass of the first tire I1 according to the invention is equal to 8.5 kg. The mass of the second reference tire R2 is equal to 9.1 kg, and the mass of the second tire I2 according to the invention is equal to 8.5 kg.

The tires I1 and R1, for the one part, and I2 and R2, for the other part, were subjected to a variety of tests and comparative measurements. The results, which are presented in Table 1 below, are expressed respectively for I1 with respect to R1 (reference or base 100), and for I2 with respect to R2 (reference or base 100):

TABLE 1

| | Difference in | | Difference in | |
|---|---|---|---|---|
| | performance of | | performance of | |
| Performance | tire I1/tire R1 | | tire I2/tire R2 | |
| Rolling resistance | −1.2 | kg/t | −1.3 | kg/t |
| Longitudinal grip (braking distance) | 111 | | 100 | |
| on wet ground (base 100) | | | | |
| Longitudinal grip (braking distance) | 102 | | 99 | |
| on dry ground (base 100) | | | | |
| Transverse grip (time to carry out a | −1.3 | s | +5 | s |
| circuit lap) on wet ground | | | | |
| Lateral stiffness at low acceleration | 89 | | 96 | |
| (or cornering stiffness) (base 100) | | | | |
| Mass | −0.6 | kg | −0.6 | kg |

Compared with the prior art tire R1 taken as a reference, the tire I1 according to the invention exhibits a reduction in rolling resistance of 1.2 kg/t, an improvement in longitudinal grip (significant on wet ground but less so on dry ground), an improved performance in terms of transverse grip on wet ground (with a time to carry out a circuit lap reduced by 1.3 s, for a reference lap time equal to 103 s), and a reduction in lateral rigidity at low acceleration implying a slight worsening in behaviour. An improvement in mass performance, that is to say a reduction in mass equal to 0.6 kg for the tire I1 compared with the tire R1 is also noted.

Compared with the prior art tire R2 taken as a reference, the tire I2 according to the invention exhibits a reduction in rolling resistance of 1.3 kg/t, an equivalent performance in terms of longitudinal grip on wet ground and on dry ground, a slightly worse performance in terms of transverse grip on wet ground (with a time to carry out a circuit lap increased by 5 s, for a reference lap time equal to 103 s), and a slight reduction in lateral rigidity at low acceleration implying substantially equivalent behaviour. An improvement in mass performance, that is to say a reduction in mass equal to 0.6 kg for the tire I2 compared with the tire R2 is also noted.

1. A tire for a passenger vehicle, comprising:
a tread that is intended to come into contact with the ground via a tread surface and comprises raised elements extending radially outwards from a bottom surface to the tread surface over a radial height H_{S}, measured in an equatorial plane XZ of the tire, at most equal to 8 mm,
the raised elements having a total volume V_{P} and being separated by voids having a total volume V_{C}, some of the voids being main voids, each having a mean width at least equal to 6 mm, and the set of main voids having a total volume V_{CP},
the tread having a volumetric void ratio T_{EV}, defined as being the ratio between the total volume V_{C} of the voids and the sum of the total volume V_{C} of the voids and the total volume V_{P} of the raised elements, at least equal to 22% and at most equal to 30%,
the tread also comprising at least one elastomeric compound having a glass transition temperature T_{g}, a Shore A hardness and a dynamic loss tgδ at 23° C.,
a hoop reinforcement, radially on the inside of the tread, comprising at least one hooping layer comprising textile reinforcers that are coated in an elastomeric compound, are mutually parallel and form, with a circumferential direction XX′ of the tire, an angle A_{F}, measured in the equatorial plane XZ of the tire, at most equal to 5° in terms of absolute value,
a working reinforcement, radially on the inside of the hoop reinforcement, comprising at least two, radially superposed working layers comprising metal reinforcers that are coated in an elastomeric compound, are mutually parallel in each layer and are crossed from one layer to the next, forming, with the circumferential direction XX′ of the tire, an angle (A_{T1}, A_{T2}), measured in the equatorial plane XZ of the tire, with an absolute value at least equal to 20° and at most equal to 40°,
a carcass reinforcement comprising at least one carcass layer comprising textile reinforcers that are coated in an elastomeric material, are mutually parallel and form, with the circumferential direction XX′ of the tire, an angle A_{C} at least equal to 85° and at most equal to 95°,
wherein the radial height H_{S} of the raised elements of the tread is at least equal to 5.0 mm, in that the total volume V_{CP} of the set of main voids in the tread is at least equal to 80% of the total volume V_{C} of the voids in the tread, in that the at least one elastomeric compound that makes up the tread has a glass transition temperature T_{g} at least equal to −22° C. and at most equal to −5° C., a Shore A hardness at least equal to 45 and at most equal to 65, and a dynamic loss tgδ at 23° C. at least equal to 0.13 and at most equal to 0.39, in that the metal reinforcers of each of the at least two working layers of the working reinforcement are steel monofilaments having a cross section S inscribed in a circle of diameter D, the smallest dimension Dmin of which is at least equal to 0.20 mm and at most equal to 0.5 mm, in that the metal reinforcers of each of the at least two working layers of the working reinforcement are distributed at a density d_{T} at least equal to 100 threads/dm and at most equal to 200 threads/dm, and in that each working layer of the working reinforcement has a mean radial thickness E_{T} at least equal to D+0.1 mm and at most equal to D+0.6 mm, where D is the diameter of the circle circumscribed on the cross section S of the monofilament-type metal reinforcer.

2. The tire according to claim 1, wherein the radial height H_{S} of the raised elements of the tread is at least equal to 5.5 mm and at most equal to 7.5 mm.

3. The tire according to claim 1, wherein the volumetric void ratio T_{EV} of the tread is at most equal to 28%.

4. The tire according to claim 1, wherein the volumetric void ratio T_{EV} of the tread is at least equal to 25% and at most equal to 27%.

5. The tire according to claim 1, wherein the total volume V_{CP} of the set of main voids in the tread is at least equal to 85%, preferably at least equal to 88%, of the total volume V_{C} of the voids in the tread.

6. The tire according to claim 1, wherein the at least one elastomeric compound that makes up the tread has a glass transition temperature T_{g} at least equal to −16° C. and at most equal to −8° C.

7. The tire according to claim 1, wherein the at least one elastomeric compound that makes up the tread has a Shore A hardness at least equal to 50 and at most equal to 63.

8. The tire according to claim 1, wherein the at least one elastomeric compound that makes up the tread has a Shore A hardness at least equal to 52 and at most equal to 57.

9. The tire according to claim 1, wherein the at least one elastomeric compound that makes up the tread has a dynamic loss tgδ at 23° C. at most equal to 0.27.

10. The tire according to claim 1, wherein the textile reinforcers of the at least one hooping layer of the hoop reinforcement comprise an aromatic polyamide, such as aramid.

11. The tire according to claim 10, wherein the textile reinforcers of the at least one hooping layer of the hoop reinforcement comprise a combination of an aromatic polyamide, such as aramid, and an aliphatic polyamide, such as nylon.

12. The tire according to claim 10, wherein the textile reinforcers of the at least one hooping layer of the hoop reinforcement comprise a combination of an aromatic polyamide, such as aramid, and a polyester, such as polyethylene terephthalate (PET).

13. The tire according to claim 1, wherein the metal reinforcers of each of the at least two working layers of the working reinforcement form, with the circumferential direction XX′ of the tire, an angle (A_{T1}, A_{T2}), measured in the equatorial plane XZ of the tire, with an absolute value at most equal to 30°.

14. The tire according to claim 1, wherein the metal reinforcers of each of the at least two working layers of the working reinforcement are monofilaments having a cross section S, the smallest dimension Dmin of which is at least equal to 0.30 mm and at most equal to 0.4 mm.

15. The tire according to claim 1, wherein the metal reinforcers of each of the at least two working layers of the working reinforcement are steel monofilaments, the ultimate tensile strength Rm of which is at least equal to 3000 MPa.

16. The tire according to claim 1, wherein the metal reinforcers of each of the at least two working layers of the working reinforcement are distributed at a density d_{T} at least equal to 120 threads/dm and at most equal to 180 threads/dm.

17. The tire according to claim 1, wherein each working layer of the working reinforcement has a mean radial thickness E_{T} at least equal to D+0.3 mm and at most equal to D+0.5 mm, where D is the diameter of the circle circumscribed on the cross section S of the monofilament-type metal reinforcer.

18. The tire according to claim 1, wherein an intermediate layer comprising at least one elastomeric compound is positioned radially on the inside of the tread and radially on the outside of the hoop reinforcement.

19. The tire according to claim 1 claim 18, wherein the intermediate layer advantageously has a radial thickness E at least equal to 0.3 mm and at most equal to 4.0 mm.

20. The tire according to claim 18, wherein the at least one elastomeric compound that makes up the intermediate layer has a Shore A hardness at least equal to 59 and at most equal to 69 and a dynamic loss tgδ at 23° C. at least equal to 0.08 and at most equal to 0.20.

21. (canceled)
